(19) United States
(12) Patent Application Publication
(10) Pub. No.: US 2018/0043434 A1
(43) Pub. Date: Feb. 15, 2018

(54) METHOD OF FORMING A COMPONENT

(71) Applicant: The Timken Company, North Canton, OH (US)

(72) Inventors: Praveen Pauskar, Massillon, OH (US); Richard J. Abbruzzi, Canton, OH (US); Wayne V. Denny, Alliance, OH (US); Stephen P. Johnson, North Canton, OH (US)

(21) Appl. No.: 15/729,773

(22) Filed: Oct. 11, 2017

Related U.S. Application Data
(63) Continuation-in-part of application No. 15/377,870, filed on Dec. 13, 2016, now Pat. No. 9,810,264.
Application No. 15/377,870 is a continuation of application No. PCT/US2016/028079, filed on Apr. 18, 2016.
(60) Provisional application No. 62/151,705, filed on Apr. 23, 2015.

(51) Int. Cl. B22F 3/16; B24B 39/00; F16C 33/64; B33Y 10/00; B22F 3/105; B22F 3/24; B29C 64/165; B23P 15/00; B22F 3/00

(52) U.S. Cl. CPC B22F 3/164; B23P 15/003; B24B 39/00; F16C 33/64; B22F 3/008; B22F 3/1055; B22F 3/162; B22F 3/24; B29C 64/165; B33Y 10/00; F16C 2220/20; F16C 2223/02; F16C 2223/10; B22F 2003/248; B22F 2003/247; B29K 2505/00

(57) ABSTRACT

A method of forming a component from a powder metal includes forming the component to a desired shape from the powder metal, heating the component to a burnishing temperature of 900 to 1300 degrees Fahrenheit, and burnishing a surface of the component while the component is at the burnishing temperature to densify the surface.

### RELATED APPLICATIONS

This application is a continuation-in part of U.S. application Ser. No. 15/377,870 filed on Dec. 13, 2016, which is a continuation of PCT Application No. PCT/US2016/028079, filed on Apr. 18, 2016, which claims the benefit of U.S. Provisional Patent Application No. 62/151,705 filed Apr. 23, 2015, the entire content of each of these applications being hereby incorporated by reference.

### BACKGROUND

The present invention relates to components (e.g., bearings), and more specifically, to surface strengthening techniques for components.

Inclusions and porosity in metals are detrimental to the performance of highly stressed mechanical components, such as bearing components (e.g., bearing raceways). In the case of powder metallurgy, powder metal (“PM”) components inherently include porosity that results in reduced strength, making them unsuitable for various highly stressed applications. The strength of PM materials increases with a reduction in porosity. Techniques such as double-press, double-sinter, powder forging, and others have been used to reduce porosity and improve the strength of PM components. Additionally, selective densification at and near the surface of components improves the rolling and sliding contact fatigue behavior of compacted and sintered materials.

Forming mechanical components using a powder metallurgy process has many advantages, such as being able to produce parts with complex geometry near final net shape with very little or no machining operations. The typical powder metallurgy manufacturing process typically includes compacting a selected powder mix under high pressure into a shape known as a pre-form. The pre-form is then thermally treated by a process known as sintering, which causes the powder particles to fuse together. The strength of the PM part is directly related to its density. Density of pressed and sintered products depends upon the pressure at which they are compacted. Because compaction pressure is limited by the strength of the compaction tooling, sometimes multiple pressing operations (e.g., double-press) are conducted on the sintered part to increase its density. To achieve 100% density, the sintered PM part is further hot forged. To perform all these operations significantly increases the cost of manufacturing, which makes PM unattractive in the case of bearing components.

As briefly mentioned above, the surface of less than 100% densified components may be selectively strengthened via densification by the application of mechanical pressure. This can be achieved by, for example, rolling a hard roller over the surface (i.e., burnishing) and/or localized hammering (i.e., peening). Burnishing and peening help extend the operational life of the components under cyclic fatigue conditions. Previously, these processes were usually only able to accomplish densification to a depth of less than 0.5 mm, with some processes able to densify only up to 1 mm below the surface. Also, some of the pores may not be effectively closed with typical burnishing and peening techniques, which results in lower performance under rolling contact fatigue conditions.

Additive Manufacturing (“AM”), also known as 3D printing, is a term used to describe the technologies that build 3D objects by adding layer-upon-layer of material. As with PM parts, AM parts start with a powder material that is formed into the component shape. AM is becoming increasingly popular due to its ability to produce customized complex shape parts to net shape with short lead time. Both metals and polymers are widely used in AM.

One of the often mentioned limitations of AM is that the mechanical properties of the additively manufactured parts are poor compared to those of parts produced from forgings. The presence of defects such as porosity and inadequate fusion between neighboring layers are among the reasons for inferior mechanical properties in additive manufactured parts. Porosity has a detrimental effect on fatigue resistance because of a higher likelihood of crack initiation at pores close to the part surface and subsequent propagation. Poor mechanical properties is one of the reasons that AM is presently limited, specifically with regards to use in highly stressed engineering applications.

### SUMMARY

Thus, an improved method for strengthening PM and AM components via surface densification to depths greater than 1.0 mm is greatly desired. The present invention provides such a method. The inventive process can be used for bearing components, and for other, non-bearing-related components (e.g., gears and other parts) in which surface densification is desired.

In one aspect, the invention provides a method of forming a component from a powder metal. The method includes forming the component to a desired shape from the powder metal, heating the component to a burnishing temperature of 900 to 1300 degrees Fahrenheit, and burnishing a surface of the component while the component is at the burnishing temperature to densify the surface.

In another aspect, the invention provides a method of forming a bearing component from powder metal. The method includes forming the component to a desired shape from the powder metal, heating the component to a burnishing temperature of 900 to 1300 degrees Fahrenheit, and burnishing a surface of the component while the component is at the burnishing temperature to densify the surface to a depth greater than or equal to 1 mm.

In yet another aspect, the invention provides a method of forming a component from powder metal. The method includes forming the component to a desired shape from the powder metal using an additive manufacturing process, heating the component to a burnishing temperature above 500 degrees Fahrenheit, and burnishing a surface of the component while the component is at the burnishing temperature to densify the surface.

Other aspects of the invention will become apparent by consideration of the detailed description and accompanying drawings.

### BRIEF DESCRIPTION OF THE DRAWINGS

FIG. 1A is a perspective view, partially broken away, of a tapered roller bearing assembly formed using a method in accordance with an aspect of the invention.

FIG. 1B is a perspective view, partially broken away, of a cylindrical roller bearing assembly formed using a method in accordance with an aspect of the invention.

FIG. 1C is a perspective view, partially broken away, of a spherical roller bearing assembly formed using a method in accordance with an aspect of the invention.

FIG. 1D is a perspective view, partially disassembled, of a tapered spherical roller bearing assembly formed using a method in accordance with an aspect of the invention.

FIG. 1E is a perspective view, partially broken away, of a ball bearing assembly formed using a method in accordance with an aspect of the invention.

FIG. 2 is a diagram illustrating a portion of an improved component manufacturing process.

FIG. 3 is a diagram illustrating a portion of an improved component manufacturing process.

FIG. 4 is a diagram also illustrating an improved component manufacturing process.

FIG. 5 is a diagram also illustrating an improved component manufacturing process.

FIG. 6 is a cross-section of a mechanical component, illustrating a burnished depth.

FIG. 7 is a table showing the results of various performance tests.

FIGS. 8-16 illustrate various burnishing tools used in the methods diagrammatically shown in FIGS. 2-5.

FIG. 17 schematically illustrates the additive manufacturing process of binder jetting.

FIG. 18 schematically illustrates the additive manufacturing process of powder bed fusion.

FIG. 19 schematically illustrates the additive manufacturing process of laser metal deposition.

FIG. 20 schematically illustrates the additive manufacturing process of electron beam metal deposition.

FIG. 21 schematically illustrates the additive manufacturing process of 3D printing using material extrusion.

FIG. 22 is a diagram illustrating a portion of an improved component manufacturing process according to the present invention.

FIG. 23 is a diagram illustrating a portion of another improved component manufacturing process according to the present invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

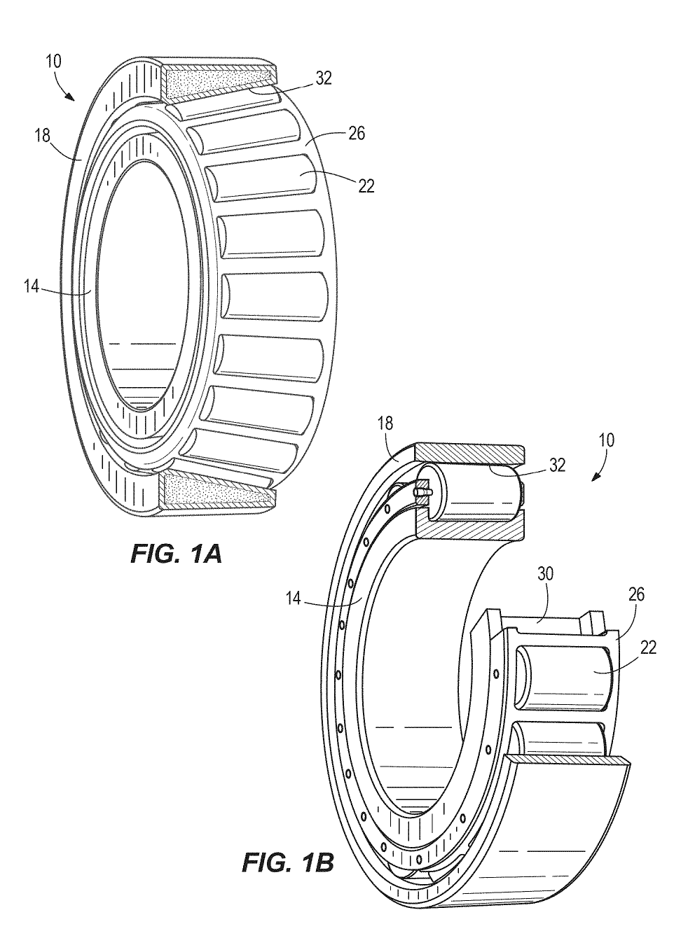

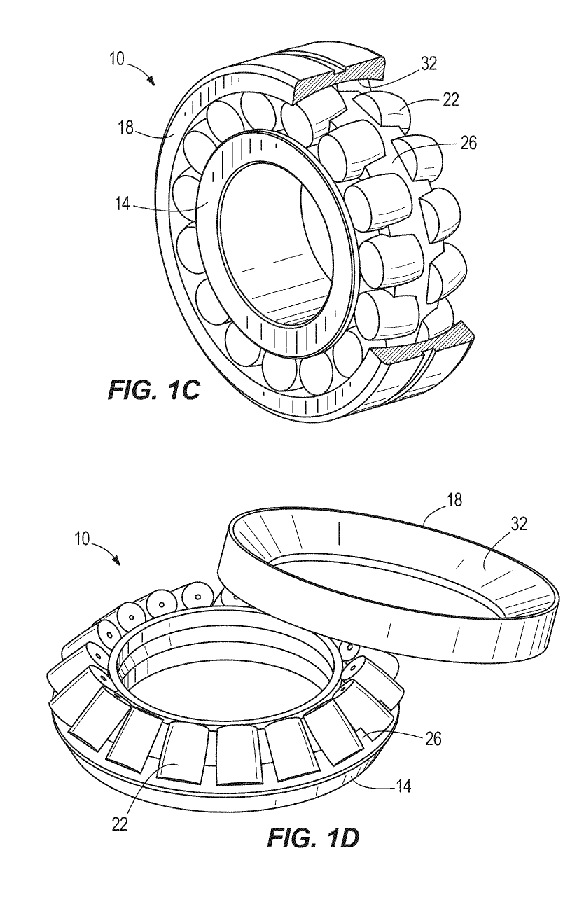

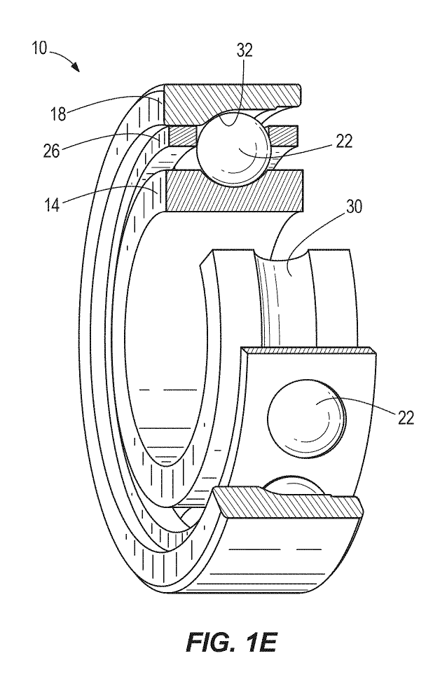

FIG. 1A illustrates a typical bearing assembly 10 usable to support a shaft in a variety of bearing applications, such that the shaft is operable to rotate and transmit force. The bearing assembly 10 includes an inner race ring 14, an outer race ring 18, and plurality of rolling elements or balls 22 positioned between the inner race ring 14 and the outer race ring 18. The plurality of rolling elements 22 can be distanced from each other or held in a desired orientation by a retainer or cage 26. In other embodiments, no cage need be used to provide a full complement bearing. While the bearing assembly 10 of FIG. 1A is illustrated as a tapered roller bearing, having tapered rollers as rolling elements 22, it is to be understood that different types of bearings with various other rolling elements (e.g., cylindrical roller (FIG. 1B), spherical roller (FIG. 1C), tapered spherical roller (FIG. 1D), ball (FIG. 1E), etc.) may also be used.

The inner race ring 14 defines an inner raceway 30 and the outer race ring 18 defines an outer raceway 32 on which the plurality of rolling elements 22 roll. The bearing assembly 10 may be created using a powder metallurgy process or using a conventional bearing manufacturing processes. The raceways 30, 32 are then densified using an improved surface densification process, as described in detail below, to provide a strengthened bearing surface with greater performance characteristics. The following description is provided in relation to densifying a powder metal (“PM”) bearing raceway; however, it is to be understood that the improved surface densification process may also be used on other mechanical components, such as gears, cams, shafts, bushings, etc.

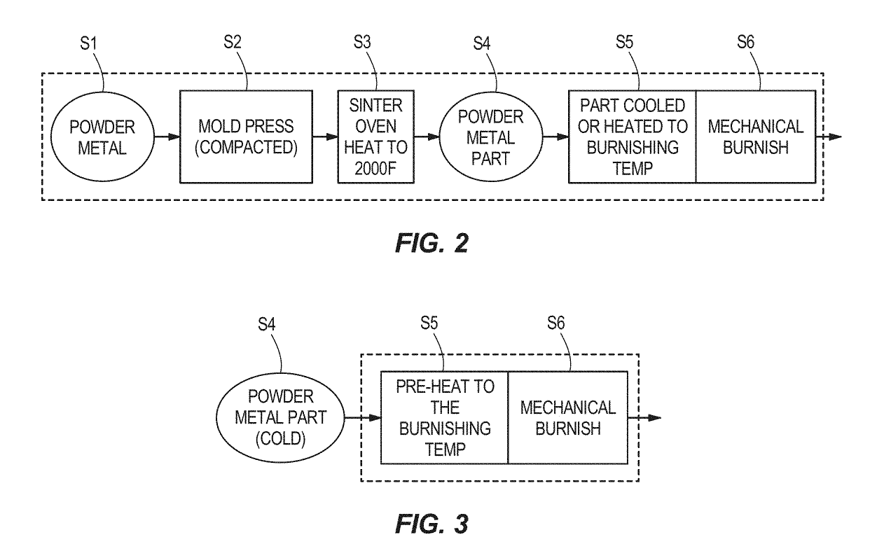

FIGS. 2-5 illustrate the process for forming the PM bearing 10 described above and densifying the raceways 30, 32. The process starts by selecting a powder metal mix (S1) and then compacting the powder metal mix under high pressure into a bearing pre-form (S2). The pre-form is then sintered at a sintering temperature of approximately 1900-2100 degrees Fahrenheit (S3), which causes the powder particles to fuse together to create a powder metal part (S4), such as the inner race ring 14 or the outer race ring 18 of the bearing 10. The PM part is then brought to a burnishing temperature above 500 degrees Fahrenheit (S5). In some embodiments, the burnishing temperature is above 800 degrees Fahrenheit. In other embodiments, the burnishing temperature is in the range of 900-1300 degrees Fahrenheit.

In one embodiment, the PM bearing component is brought to the burnishing temperature immediately following the sintering process by cooling the component from the sintering temperature to the burnishing temperature. In another embodiment, the bearing component is allowed to fully cool after the sintering process. The component is then re-heated to the burnishing temperature using, for example, induction heating or furnace heating techniques. Thus, a bearing manufacturer may outsource the manufacturing of the un-treated powder metal parts (S1-S4) and then perform the improved method of burnishing at an elevated temperature (S5-S6) at a later time, as shown in FIG. 3. While at the elevated burnishing temperature, the yield strength of, for example, steel is roughly 0.5 to 0.3 times that at room temperature, which makes it easier to plastically deform. Burnishing at temperatures greater than 1300 degrees Fahrenheit has still shown improved densification, however, this increases the complexity of the process and increases the risk of creating oxides in pores of the PM bearing component.

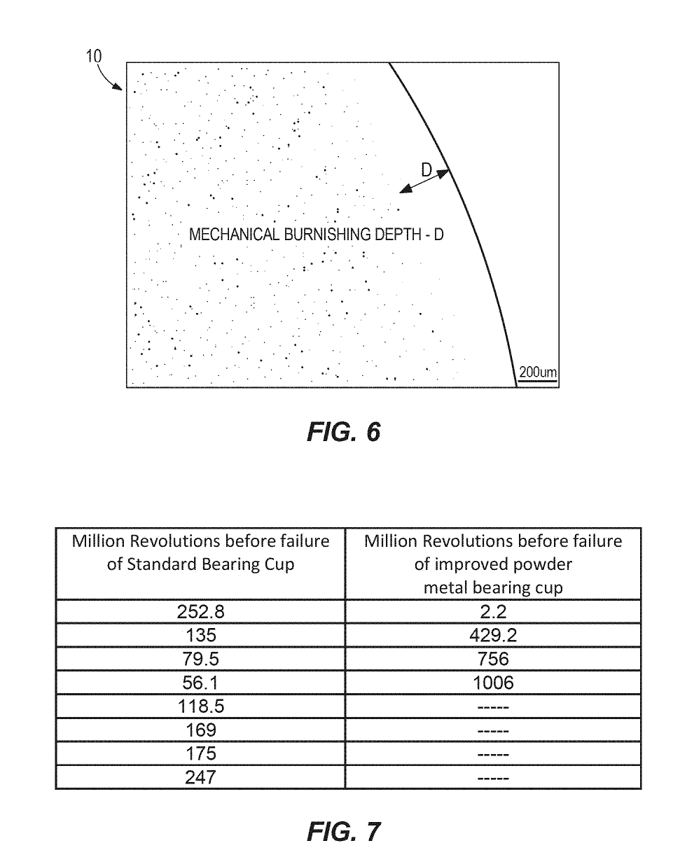

Once the bearing component is brought to the burnishing temperature, the bearing surface (e.g., one of the raceways 30, 32) is burnished (S6) by a burnishing tool 50, to be described in detail below. By burnishing at an elevated burnishing temperature, the surface of the bearing 10 will be densified to a burnishing depth D of greater than 0.5 mm (FIG. 6). In other embodiments, the burnishing depth D is greater than 1 mm, in a range of 1 to 2 mm, or even greater than 2 mm.

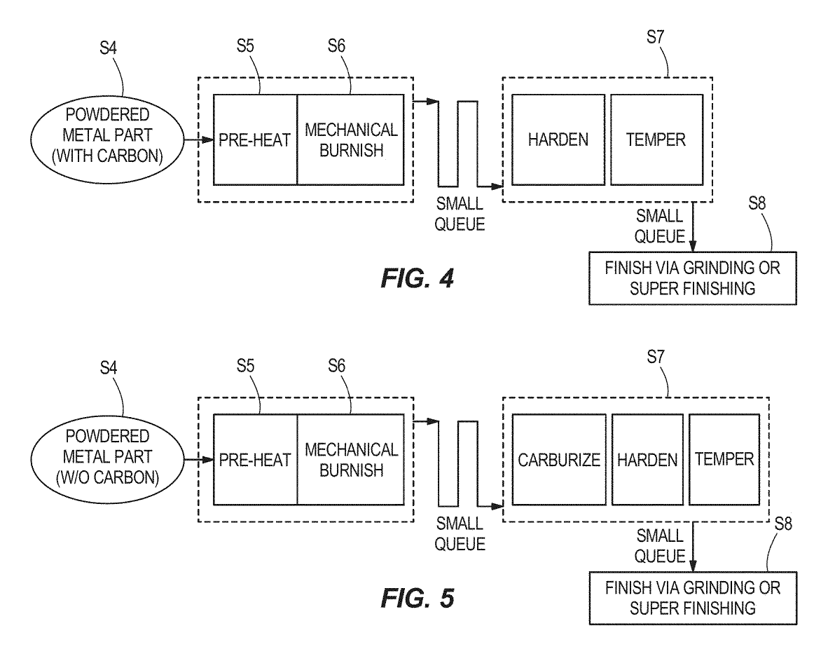

In reference to FIGS. 4 and 5, the PM bearing component may also be heat treated (S7) using a standard heat treating process after the burnishing step (S6) without cooling the component back to room temperature after the burnishing step. If the PM bearing component includes carbon, the heat treating process (S7) may include a conventional hardening process and a tempering process (FIG. 4). If the PM race rings 14, 18 do not have adequate carbon, the heat treating process (S7) may include carburizing, hardening, and tempering (FIG. 5). After heat treatment, the bearing component may then be cooled and finished (S8) using, for example, a grinding or super finishing operation. Similarly, it is to be understood that the final finishing operation (S8) may also be performed by other suitable mechanical, electrical, optical/laser-assisted, or chemical processes. As an example, the final finishing operation may be chemically assisted by a mechanical tumbling process. The method of forming and heat treating the bearing component, as described above, may be performed as a continuous in-line process, which is more efficient than a batch-style process.

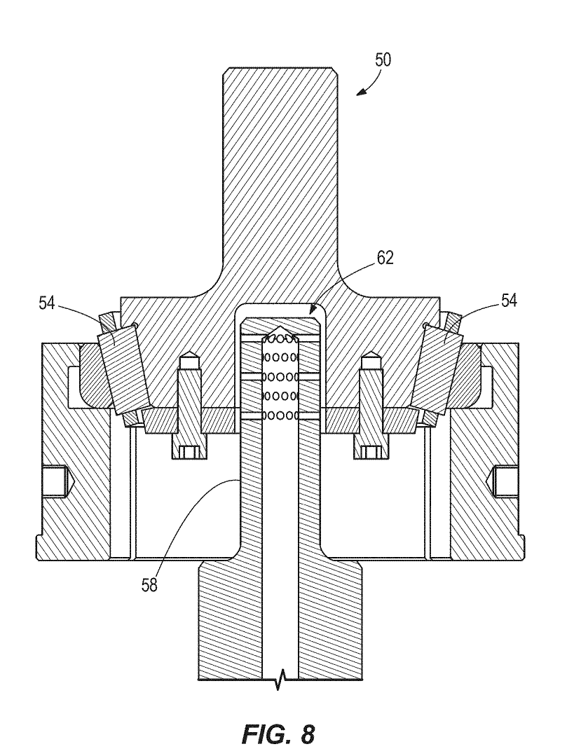

In reference to FIG. 7, the improved method for densifying a surface drastically increases the performance life of a bearing. In several test cases, standard bearing cups manufactured without the above-described inventive densification process and PM bearing cups that have been densified using the inventive processes described above were subjected to performance testing to determine their operational life. During the tests, the bearing cups were subject to equal rotational speeds under a constant radial load, with fixed lubrication and temperature conditions. The tests show that the PM bearing cups that were densified according to the invention lasted approximately 548 million revolutions on average before failing. This average even includes a single test case wherein the bearing cup failed at 2.2 million revolutions, which was likely the result of a faulty manufacturing process early in the development phase. Further, two of the PM bearing cups ran at least 750 million revolutions. One test was suspended for metallurgical evaluation at 756 million revolutions, while the other ran over a billion revolutions when one of the rolling elements failed due to fatigue. Note that the surface densified bearing ring did not fail in this bearing. On the other hand, the standard bearing cups, which were made of non-PM materials, failed at an average of approximately 154 million revolutions. From these results, it is clear that the PM bearing cups out-performed the standard case carburized cups by a significant margin (i.e., approximately 3.5 times longer). Further, it was found that the dynamic load carrying capacity of the PM cups was at least equivalent to that of the standard case carburized cups. These strong results were certainly unexpected to the inventors, who knew that such results were not achieved using known cold-burnishing techniques (i.e., burnishing techniques performed at room temperature). By using the method described herein, in which burnishing is conducted at an elevated, burnishing temperature, powder metal may now be efficiently utilized to create stronger, longer-lasting, and more reliable bearing components.

Further, the results seem to indicate that performing a similar densification process on a non-PM bearing component would also significantly increase its performance. For example, bearing components made of low-grade steel may be densified using the inventive processes described above to achieve results previously only seen with high-grade bearing steels. Additionally, high-grade bearing steels can be densified to achieve even better results than previously seen without the inventive densification process.

Additionally, the core sections of the PM bearing component unaffected by densification are relatively porous with a modulus of elasticity roughly 60% to 85% of the fully dense wrought material. Thus the raceways 30, 32 are expected to deflect more under application loads. This results in increased stresses along both edges of the raceway profile. To compensate for the lower modulus, the raceway profile can be modified by increasing the crown height 50%-100% when compared to the typical raceway crown heights used with fully dense wrought material.

While performing the mechanical burnishing operation at an elevated burnishing temperature, a significant amount of heat is conducted from the warm PM bearing component onto the burnishing tool 50, and especially any burnishing rollers 54 (FIG. 8). Consequently, the burnishing tool 50 may include a cooling mechanism and/or insulation so as to minimize heat conduction to the burnishing tool 50. For example, as shown in FIG. 8, a cooling conduit or quenching spindle 58 may be receivable within a cavity 62 of the burnishing tool 50 for spraying a cool substance (e.g., water, etc.) on the tool 50 for cooling purposes. Further, high-temperature, high-strength steels (e.g., H13, M50) or ceramic (e.g., silicon nitride) can be used to form the burnishing rollers 54. This also helps improve the life of various tooling components.

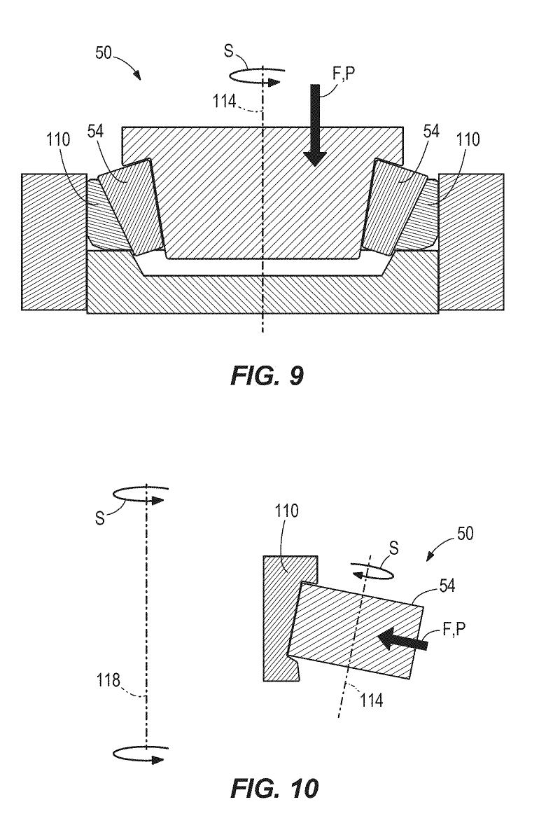

In operation of the burnishing tool 50, the burnishing rollers 54 are brought into contact with the corresponding bearing component (designated as 110 in FIGS. 9-16). The rollers 54 are rotated about a roller axis 114, while the bearing component 110 is either stationary or rotating in the opposite direction to the tool 50 about a bearing component axis 118. The rotational speed between the tool 50, the rollers 54, and the bearing component 110 is set at a speed S while applying a force F by moving the tool 50 to a position P with respect to the bearing surface as it is at the burnishing temperature T. The parameters (i.e., speed S, force F, position P, and burnishing temperature T) are controlled and/or monitored to provide a desired surface densification D. The complete burnishing cycle can have three embodiments. Cycle 1 includes tool 50 and rollers 54 operating in step 1 clockwise rotation, followed by step 2 counter-clockwise rotation. Cycle 2 includes only clockwise rotation. Cycle 3 includes only counter-clockwise rotation. Complete burnishing cycles are selected depending on material properties desired for a given application.

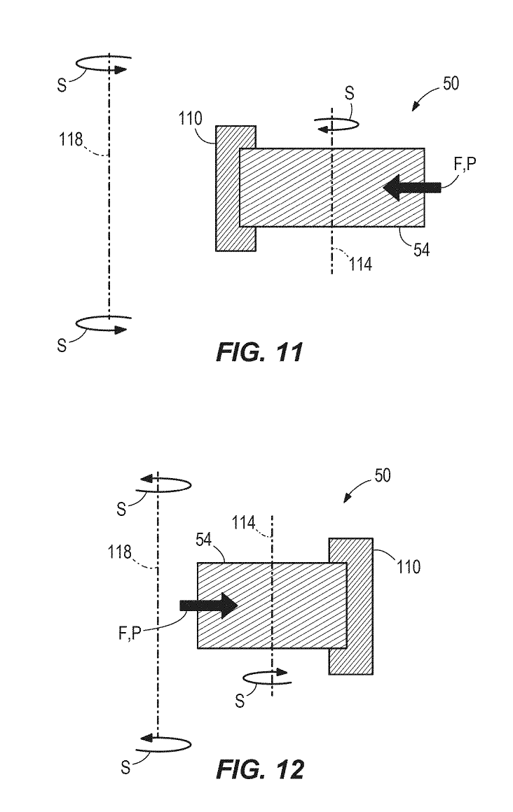

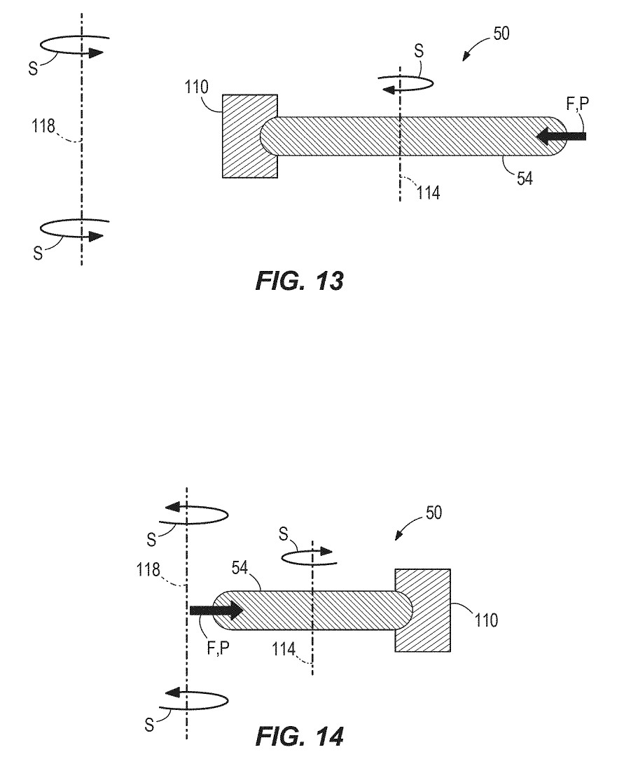

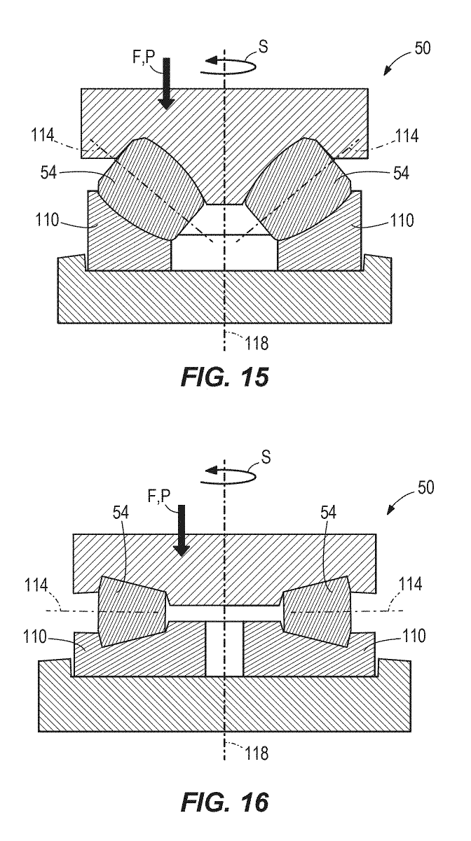

In various embodiments of the burnishing tool 50 (FIGS. 9-16), the configuration of the tool 50 and/or the rollers 54 are altered such that the tool 50 may be used to densify the raceways of other types of bearings, such as tapered roller bearings (FIGS. 9 and 10), cylindrical roller bearings (FIGS. 11 and 12), ball bearings (FIGS. 13-14), thrust spherical roller bearings (FIG. 15), thrust taper roller bearings (FIG. 16), or the like.

There are numerous AM processes known and used for rapidly creating components of various geometries. Bearing components, gears, and other like components made by AM processes can likewise benefit from burnishing the formed component at elevated temperatures. Some known AM processes are described below.

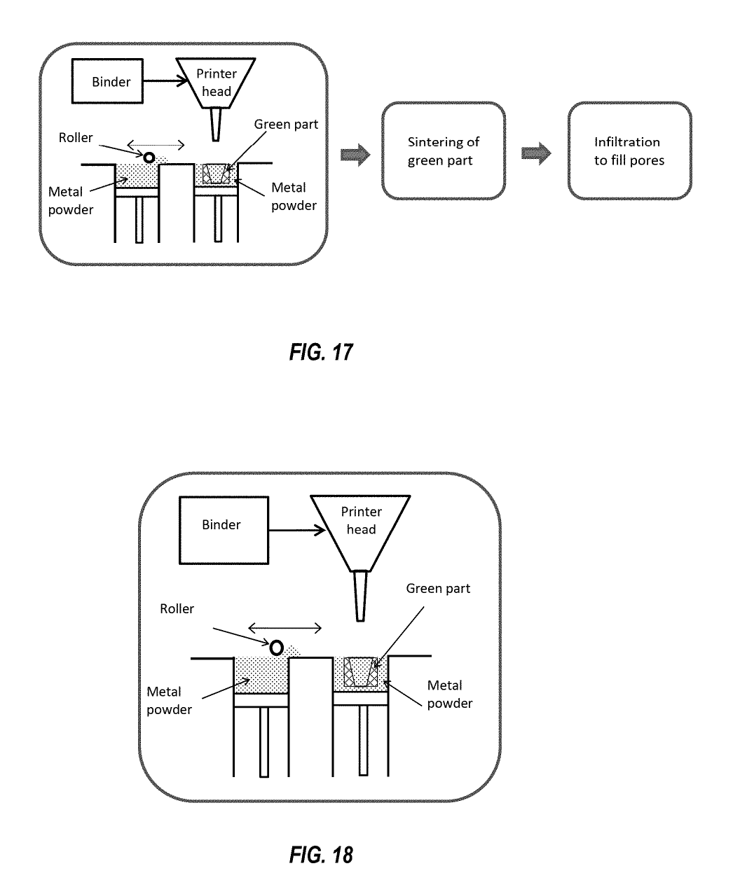

Binder Jetting is an additive manufacturing process in which a liquid binding agent is selectively deposited to join metal powder particles. This process starts by spreading a thin layer of powder over a build platform. The print head then dispenses a binder adhesive on top of the powder where binding of powder particles is required. Unbound powder remains in position. The build platform is then lowered by the amount equal to the model's layer thickness (about 0.1-0.2 mm) and another layer of powder is spread over the previous layer. The process of spreading powder and binder dispensing is repeated layer by layer until the entire object has been created. The printed object is then cured/sintered to fuse the metal particles together. Depending upon the powder size and binder used, it is not uncommon to see a high level of porosity (about 20-30%) in the sintered part. A Hot Isostatic Pressing (HIP) process is sometimes employed after sintering to achieve higher densities. Alternatively, the sintered steel part is infiltrated with another material such as copper or bronze for improved strength. In either case, porosity is difficult to fully eliminate. FIG. 17 schematically illustrates the binder jetting process.

Powder bed fusion (PBF) processes use either a laser or electron beam to melt and fuse material powder together. All PBF processes involve the spreading of metal powder material over previous layers. Energy from the laser sinters the powder layer by layer to build a solid object. It is possible to get relatively high density (98-99%) using powder bed fusion processes. However, it is noted that residual porosity and incomplete fusion between layers can result in poor fatigue properties. FIG. 18 schematically illustrates the PBF process.

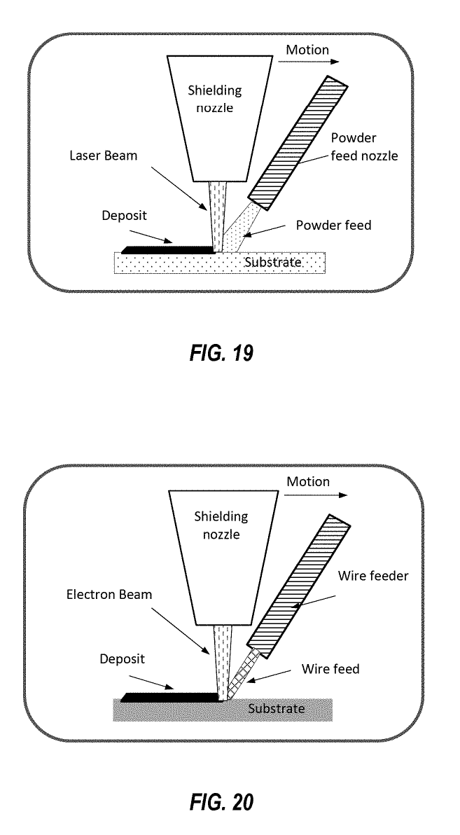

Direct energy deposition is commonly used to repair or add additional material to an existing component. A typical direct metal deposition process consists of a nozzle through which powder metal is fed onto a specified surface where it is melted by a laser. Other variations of this process uses wire feed instead of powder and electron beam as the energy source. The melted material upon solidification is jointed to the substrate and form a new surface layer. It is often noted that this new deposited surface layer has significant porosity which can have a direct effect on performance under fatigue loading conditions. FIG. 19 schematically illustrates the direct energy deposition process utilizing a laser, and FIG. 20 schematically illustrates the direct energy deposition process utilizing an electron beam.

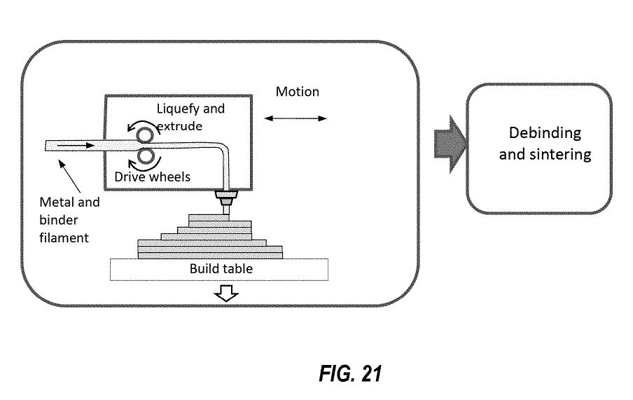

Material extrusion starts with fine metal powder which is mixed with a plastic binder to form feedstock in the form of filaments. The filament is then passed through a heated nozzle that extrudes and deposits the filiment into the part shape of the part one layer at a time (3D printing). After printing, the part is sintered in a furnace, burning off the binder and solidifying the powder into the final metal part. High levels of densities (97-99%) can be achieved in the sintered part. To achieve a fully dense structure, a HIP process may be added. FIG. 21 schematically illustrates the material extrusion process.

These and other AM processes can be used to fabricate metal components. All AM methods are known to have some level of residual porosity, which has an adverse effect on mechanical properties. In highly stressed applications, such as gears and bearings where the surfaces experience fatigue loading, it is important to eliminate near surface porosity. It is believed that the same techniques described above for burnishing PM components at an elevated burnishing temperature can be used in the same manner and will perform equally as well for components made by AM processes. The same advantageous results discussed above, including the component densification depths D and the performance life of a bearing made from such AM components, are expected to be achieved. This is due to the fact that the powders used to make each of the PM and the AM part can be the same, such as steel alloy powders in the case of bearing components and gears. It is believed that the powder metal material, and not the specific manner in which it is formed into the un-burnished component, dictates the characteristics achieved via the elevated temperature burnishing.

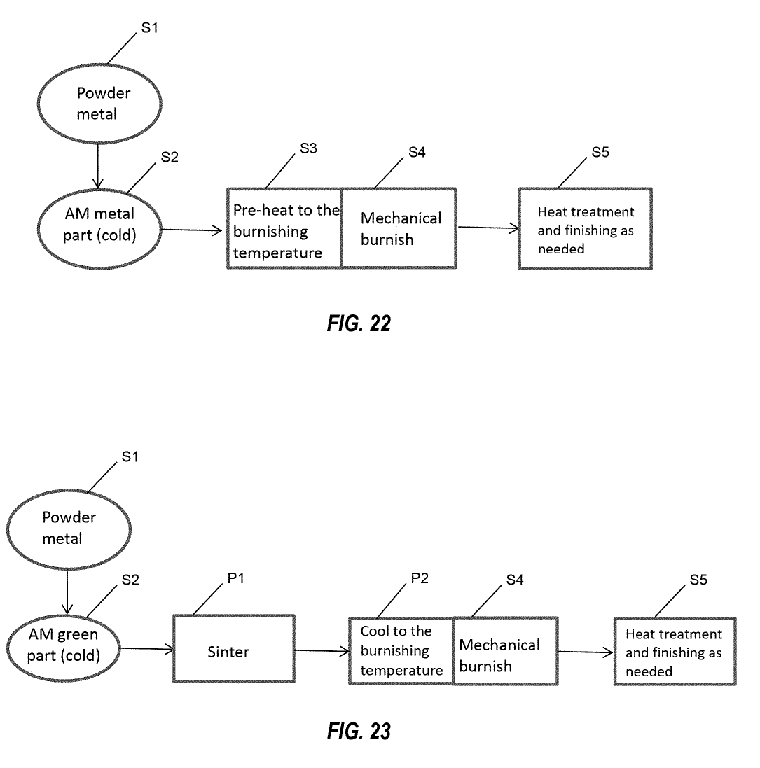

FIG. 22 illustrates the process for forming an AM bearing 10 as described above and densifying the raceways 30, 32. The process starts by selecting a powder metal mix (S1) and then forming the component via AM (S2) using any AM processes, including but not limited to those discussed above. The completed AM part is then brought to a burnishing temperature above 500 degrees Fahrenheit (S3). In some embodiments, the burnishing temperature is above 800 degrees Fahrenheit. In other embodiments, the burnishing temperature is in the range of 900-1300 degrees Fahrenheit. Just as the 900-1300 degrees Fahrenheit range has been found to achieve better-than-expected results in steel bearing components made from PM processes, it is believed that the same results can and will be achieved in steel bearing components and other steel components made from AM processes. Once again, it is believed that the results are achieved based on the powder material that is being burnished at the elevated burnishing temperature, and not based on the particular manner in which the powder material is formed into a component.

Once the bearing component is brought to the burnishing temperature, the bearing surface (e.g., one of the raceways 30, 32) is burnished (S4) by a burnishing tool 50, in the same manner described in detail above. By burnishing at an elevated burnishing temperature, the surface of the bearing 10 will be densified to a burnishing depth D of greater than 0.5 mm (FIG. 6). In other embodiments, the burnishing depth D is greater than 1 mm, in a range of 1 to 2 mm, or even greater than 2 mm. The AM bearing component may also be heat treated (S5) in any of the same manners and methods described above after the burnishing step (S4).

In one embodiment (see FIG. 23), the AM bearing component is brought to the burnishing temperature immediately following a sintering process (P1) employed as part of the AM process. After sintering the AM part, the component is cooled from the sintering temperature to the burnishing temperature (P2). The part can then be burnished without the need to re-heat the part to the burnishing temperature. In other embodiments, the bearing component is allowed to fully cool after the sintering process. The component is then re-heated to the burnishing temperature using, for example, induction heating or furnace heating techniques. Thus, a bearing manufacturer may outsource the manufacturing of the un-treated AM parts and then perform the improved method of burnishing at an elevated temperature at a later time, as shown in FIG. 22.

As with the elevated-temperature burnishing of the PM components described above, AM components burnished according to the present invention can result in favorable residual compressive stresses in the components that extend the operational life of the product under fatigue conditions. The above processes are useful for components, such as bearing components and gears, which are subjected to high Hertzian contact stresses and cyclic fatigue conditions.

Those skilled in the art will understand that the AM components can be designed so that they can withstand and benefit from the elevated-temperature burnishing. For example, hollow portions or cavities formed in AM components may be spaced far enough away from surfaces to be burnished so that the burnishing forces do not damage the part. In other embodiments, it may be possible to temporarily fill such hollow spaces or cavities for added support during burnishing. The fill or support material can then be removed once burnishing is completed.

Various features and advantages of the invention are set forth in the following claims.

What is claimed is:

1. A method of forming a component from a powder metal, the method comprising:
forming the component to a desired shape from the powder metal;
heating the component to a burnishing temperature of 900 to 1300 degrees Fahrenheit; and
burnishing a surface of the component while the component is at the burnishing temperature to densify the surface.

2. The method of claim 1, wherein forming the component to the desired shape from the powder metal includes
pressing the powder metal; and
sintering the power metal to form the component.

3. The method of claim 1, wherein forming the component to the desired shape from the powder metal includes using an additive manufacturing process.

4. The method of claim 3, wherein the additive manufacturing process includes any one of binder jetting, powder bed fusion, direct energy deposition, or material extrusion.

5. The method of claim 1, wherein heating the component includes sintering the component at a sintering temperature above the burnishing temperature and cooling the component to the burnishing temperature after sintering the component.

6. The method of claim 1, further including sintering the component and cooling the component to a temperature below the burnishing temperature after sintering the component, and wherein heating the component is performed after the component has been cooled following sintering.

7. The method of claim 1, wherein burnishing includes using a burnishing tool with a cooling mechanism or insulation or both.

8. The method of claim 1, wherein the component is a bearing component.

9. The method of claim 8, wherein the bearing component includes one of a ball bearing raceway, a tapered roller bearing raceway, a spherical roller bearing raceway, a tapered spherical roller bearing raceway, or a cylindrical roller bearing raceway.

10. The method of claim 1, further comprising:
heat treating the component; and
finishing the component.

11. The method of claim 10, wherein heat treating the component further includes continued heating of the component to a heat treatment temperature greater than the burnishing temperature following burnishing the surface of the component.

12. The method of claim 10, wherein finishing the component includes using a grinding or a super finishing operation or both.

13. The method of claim 1, wherein the surface is densified to a depth greater than or equal to 1 mm.

14. The method of claim 1, wherein the surface is densified to a depth greater than 1 mm and up to 2 mm.

15. The method of claim 1, wherein the surface is densified to a depth in the range of 0.5 mm to 2 mm.

16. A method of forming a bearing component from powder metal, the method comprising:
forming the component to a desired shape from the powder metal;
heating the component to a burnishing temperature of 900 to 1300 degrees Fahrenheit; and
burnishing a surface of the component while the component is at the burnishing temperature to densify the surface to a depth greater than or equal to 1 mm.

17. The method of claim 16, wherein forming the component to the desired shape from the powder metal includes
pressing the powder metal; and
sintering the power metal to form the component.

18. The method of claim 16, wherein forming the component to the desired shape from the powder metal includes using an additive manufacturing process.

19. The method of claim 18, wherein the additive manufacturing process includes any one of binder jetting, powder bed fusion, direct energy deposition, or material extrusion.

20. A method of forming a component from powder metal, the method comprising:
forming the component to a desired shape from the powder metal using an additive manufacturing process;
heating the component to a burnishing temperature above 500 degrees Fahrenheit; and
burnishing a surface of the component while the component is at the burnishing temperature to densify the surface.
